(19) United States
(12) Patent Application Publication
(10) Pub. No.: US 2008/0191616 A1
(43) Pub. Date: Aug. 14, 2008

(54) Polymer light-emitting devices based on interfaces enables by internally compensated doped conjugated ionomers

(76) Inventor: Mark C. Lonergan, Eugene, OR (US)

Correspondence Address: LUMEN PATENT FIRM, INC., 2345 YALE STREET, SECOND FLOOR, PALO ALTO, CA, 94306, US

(21) Appl. No.: 12/002,306

(22) Filed: Dec. 13, 2007

Related U.S. Application Data
(63) Continuation-in-part of application No. 11/820,860, filed on Jun. 20, 2007, now abandoned.
(60) Provisional application No. 60/815,429, filed on Jun. 20, 2006.

(51) Int. Cl. H01J 1/63

(52) U.S. Cl. 313/504

(57) ABSTRACT

Solid-state, electrically driven polymer light emitting devices based on two or more layers of conjugated polymers are provided. At least one of the layers is an internally compensated doped conjugated ionomer. Such internally compensated doped conjugated ionomers are used to fabricate efficient light-emitting device structures that are not possible with more conventional doped conjugated polymers because of the problem of dopant ion diffusion in the latter.

### CROSS-REFERENCE TO RELATED APPLICATIONS

This application is a continuation-in-part of U.S. patent application Ser. No. 11/820,860 filed Jun. 20, 2007, which claims priority from U.S. provisional patent application No. 60/815,429 filed Jun. 20, 2006, both of which are incorporated herein by reference.

### STATEMENT OF GOVERNMENT SPONSORED SUPPORT

This invention was made with Government support under Grant No. DMR 0210078 awarded by the NSF. The US Government has certain rights in this invention.

### FIELD OF THE INVENTION

The present invention relates generally to light emitting devices and methods. More specifically, it relates to solid-state polymer light-emitting devices.

### BACKGROUND OF THE INVENTION

The ability for dopant ions to diffuse through and permeate conjugated polymers has at least two major consequences in the development of polymer electronics: i) traditionally doped conjugated polymers cannot support charge depletion layers, i.e., with traditionally doped conjugated polymers, charge depletion layers of sufficient width to yield current rectification are not possible due to dopant ion diffusion through the polymer (an issue of permeability); ii) interfaces between differentially doped conventional conjugated polymers are unstable with respect to interfacial redox chemistry, i.e., traditionally doped polymers, although potentially ideal on an energetic basis, cannot generally be used as carrier injecting contacts to intrinsic luminescent polymers because the mobility of dopant atoms supports interfacial bulk chemical reactions. These considerations substantially limit the range of device architectures possible with traditional conjugated polymers. In an article entitled “A Conjugated Polymer pn Junction” (J. Am. Chem. Soc., 126(34), 10536-10537, 2004), the present inventor described an example of a polymeric junction between n-doped and p-doped regions. (Note: the term “polymer p-n junction” may be used to refer to such junctions, but this term also has other meanings in the literature.) Although the article suggests the possibility of using these junctions for practical electronic devices, it is significant to note that this prior work was based on non-luminescent polymers, and did not include specific applications or architectures for light-emitting devices. In addition, as mentioned above, certain problems remained unsolved that prevented the realization of such ideas. For example, the problem of dopant ion diffusion severely limits the efficiency and usefulness of devices based on conventional doped conjugated polymers. It would therefore be a significant contribution to the art to provide polymeric devices that overcome these problems.

### SUMMARY OF THE INVENTION

The present invention provides a solid-state, electrically driven polymer light emitting devices based on two or more layers of conjugated polymers, at least one of which is an internally compensated doped conjugated ionomer.

In one aspect, a light-emitting device has a first layer composed of a first conjugated polymer material and a second layer composed of a second conjugated polymer material chemically distinct from the first conjugated polymer material, where the first and second layers are in contact. The first conjugated polymer material is an internally compensated doped conjugated ionomer, and the second conjugated polymer material is luminescent. The internally compensated doped conjugated ionomer has a doping density and an ion density. The ion density refers specifically to the density of bound counter-ions. Preferably, the ion density is at least as large as the doping density. More preferably, the doping density is at least 1013 per cm³ and the ion density is at most 10²³ per cm³.

In some embodiments, the layers themselves serve as electrodes. In other embodiments, the device has a first electrode in contact with the first layer and a second electrode in contact with the second layer so that the first layer and the second layer are sandwiched between the first electrode and second electrode. Preferably, at least one of the first electrode and the second electrode is transparent to visible light.

In one particular realization of the device (having a p-n structure), both first and second conjugated polymer materials are luminescent and both are internally compensated doped conjugated ionomers, where the first conjugated polymer material is p-doped and the second conjugated polymer material is n-doped. The first conjugated polymer material and the second conjugated polymer material are ionically functionalized forms of a conjugated polymer with oppositely charged ionic functional groups—the p-doped material having the anionic functionality covalently bound to the backbone and the n-doped material having the cationic functionality covalently bound to the backbone. The conjugated polymer backbone may be, for example, poly(p-phenylene vinylene), poly(fluorene) or poly(terphenylene vinylene). The first and second layers are composed of chemically distinct polymer materials.

In an alternate realization of the device (having a p-i or n-i structure), the first conjugated polymer material layer is p-doped or n-doped internally compensated conjugated ionomer, and the second conjugated polymer material layer is an undoped (intrinsic) material that is luminescent. For example, the second conjugated polymer material may be poly(p-phenylene vinylene), poly(fluorene), or poly(terphenylene vinylene). The first and second layers are composed of chemically distinct polymer materials.

Another realization of the device (having a p-i-n structure) has three layers of conjugated polymer materials. A first conjugated polymer material is an internally compensated p-doped conjugated ionomer, and a third conjugated polymer material is an internally compensated n-doped conjugated ionomer. The first and the third conjugated polymer materials are ionically functionalized forms of conjugated polymers with oppositely charged ionic functional groups—the p-doped material having the anionic functionality covalently bound to the backbone and the n-doped material having the cationic functionality covalently bound to the backbone. Sandwiched between these material layers is a second conjugated polymer that is undoped (intrinsic) and luminescent. As before, the second conjugated polymer material may be, for example, poly(p-phenylene vinylene), poly(fluorene), or poly(terphenylene vinylene). The first, second, and third layers are composed of chemically distinct polymer materials.

### BRIEF DESCRIPTION OF THE DRAWINGS

FIG. 1 is a schematic diagram illustrating the structure of a light-emitting device according to an embodiment of the invention.

FIGS. 2A-B illustrate a device which has a p-n structure according to an embodiment of the invention.

FIGS. 3A-B illustrate a device which has a p-i (or n-i) structure according to an embodiment of the invention.

FIGS. 4A-B illustrate a device which has a p-i-n structure according to an embodiment of the invention.

FIGS. 5A-B show an internally compensated p-doped polyacetylene and an internally compensated n-doped polyacetylene, respectively, according to embodiments of the invention.

FIGS. 6A-C illustrate the synthesis of ionomers which may be used in embodiments of the present invention.

FIGS. 6D-F illustrate the synthesis of monomers which may be used in embodiments of the present invention.

### DETAILED DESCRIPTION

The present invention provides a solid-state, electrically driven polymer light emitting devices based on two or more layers of conjugated polymers, at least one of which is an internally compensated doped conjugated ionomer.

A conjugated ionomer is a conjugated polymer with an ionic functional group covalently bonded to the polymer backbone. Conjugated ionomers are also referred to as conjugated polyelectrolytes. A conjugated ionomer is said to be doped when charge carriers (i.e., electrons or holes) have been injected into the polymer backbone. A doped conjugated ionomer is said to be internally compensated (or self-doped) if the doping is electrically counter-balanced by the covalently bound ionic functional group. A p-doped (i.e., oxidatively doped) internally compensated conjugated polymer may be obtained from a conjugated polymer with an anionic functionality covalently bound to the polymer backbone. Similarly, and n-doped (i.e., reductively doped) internally compensated conjugated polymer may be obtained from a conjugated polymer with a cationic functionality covalently bound to the polymer backbone. For example, FIG. 5A shows an internally compensated p-doped polyacetylene and FIG. 5B shows an internally compensated n-doped polyacetylene.

In a bulk material, an internally compensated doped conjugated ionomer has a doping density and an ion density. The ion density refers to the density of covalently bound ionic functional groups. Perfect internal compensation exists when there is a precise electrical counter-balance between the doping density and ion density, although internal compensation in the present context is not limited to precise or perfect compensation. For the bulk material to be considered internally compensated, the ion density is preferably at least as large as the doping density. More preferably, the doping density is at least 10¹³ per cm³ and the ion density is at most 10²³ per cm³. Most preferably, the densities are equal. Internal compensation in the devices of the present invention provide them with distinct advantages. In particular, the internal compensation of a doped conjugated ionomer prevents interfacial reactivity because there are no mobile counter-ions to support a bulk chemical reaction or dopant ion diffusion, where dopant ion refers to those balancing the charge injected into the polymer backbone. Moreover, selection of an appropriate doping level for internal compensation allows the light emission of the device to be tuned for greater efficiency.

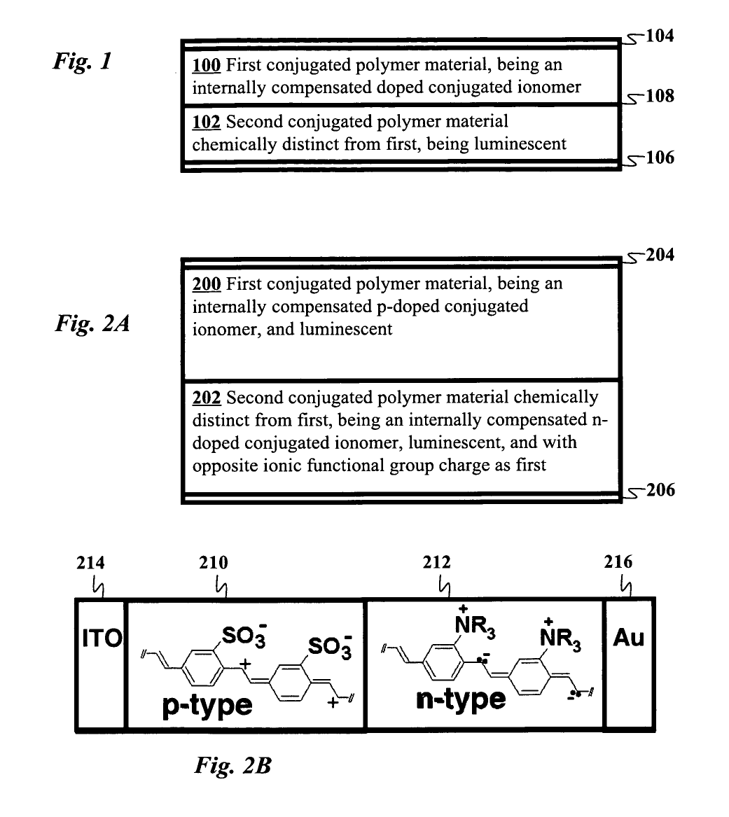

An embodiment of a light-emitting device according to the invention is shown in FIG. 1. The device has a first layer 100 composed of a first conjugated polymer material and a second layer 102 composed of a second conjugated polymer material. The first conjugated polymer material 100 is an internally compensated doped conjugated ionomer, and the second conjugated polymer material 102 is luminescent. The first and second conjugated polymer materials are chemically distinct from each other. The term “chemically distinct” when applied to two polymers is used in the context of the present description to mean that either their polymer backbones are distinct, or they are distinguished by differences in ionic functional groups bound to their backbones, or both. Thus, for example, two chemically distinct conjugated ionomers may both have identical polymer backbones, but different ionic functional groups bound to their polymer backbones.

Layers 100 and 102 are in contact at an interface 108. In some embodiments, the device has a first electrode 104 in contact with the first layer 100 and a second electrode 106 in contact with the second layer 102 so that the first layer and the second layer are sandwiched between the first electrode and second electrode. Preferably, at least one electrode is transparent to visible light. The term “transparent” is used in the present description to mean a transmission coefficient of 50% or more. In other embodiments, the layers themselves serve as electrodes.

The application of voltage bias between the electrodes 104 and 106 causes charge carriers from the first layer 100 to be injected into the second layer 102. These charge carriers are electrons or holes depending on whether the conjugated ionomer is n-doped or p-doped, respectively. In the second layer, which is luminescent, opposite charge carriers recombined, resulting in the emission of light from the device (e.g., through the transparent electrode). Preferably, the doped layer 100 has its Fermi level optimally matched with an electronic band edge of the luminescent layer 102. In particular, for efficient light emission, it is desirable that the Fermi level of an n-doped first layer is matched to the conduction band edge of the luminescent second layer, or that the Fermi level of a p-doped first layer is matched to the valence band edge of the luminescent second layer. Generally, the better the match, the greater the efficiency and the lower the drive voltage of the device. Thus, preferably, there is an equal or approximately equal match. One way this band matching can be achieved is for the conjugated polymer materials in the first and second layers to have the same type of conjugated polymer backbone. In addition, the Fermi level of the doped layer can be adjusted by appropriate selection of doping level, thereby allowing the light emission efficiency to be tuned.

### Example of p-n Structure Device

The device can be realized in several ways. For example, FIG. 2A illustrates one embodiment of the device which has a p-n structure. In this embodiment, both first and second conjugated polymer materials 200 and 202 are luminescent. In addition, both first and second polymer materials are internally compensated doped conjugated ionomers, where the first conjugated polymer material is p-doped and the second conjugated polymer material is n-doped. The first and second materials are both ionically functionalized forms of a luminescent conjugated polymer, but with oppositely charged ionic functional groups—the p-doped material having the anionic functionality covalently bound to the backbone and the n-doped material having the cationic functionality covalently bound to the backbone. The luminescent conjugated polymer backbone may be, for example, a poly(p-phenylene vinylene), a poly(fluorene) or a poly(terphenylene vinylene) polymer. The two layers are preferably sandwiched between electrodes 204 and 206.

A particular example of this embodiment is illustrated in FIG. 2B. The first layer 210 is an internally compensated p-doped conjugated ionomer with a poly(p-phenylene vinylene) polymer backbone anionically functionalized with SO₃⁻. The second layer 212 is an internally compensated n-doped conjugated ionomer with a poly(p-phenylene vinylene) polymer backbone cationically functionalized with NR₃⁺ where R is an organic functional group such as ethyl or methyl. The two polymer layers 210 and 212 are sandwiched between indium tin oxide (ITO) transparent electrode 214 and a thermally evaporated gold electrode 216. As an alternative to gold, electrode 216 could be made of other materials such as Pd, Pt, or Mg. Electrode 214 alternatively could be made of any of various other transparent conducting oxides.

The resulting structure is a diode, and the application of a forward bias to the electrodes results in the injection of electrons into the n-type material and the injection of holes into the p-type material. The electrons and holes then recombine in the vicinity of the interface between the two layers to emit light. The frequency of the light is determined by the band structure of the conjugated polymer. The light emission efficiency of the device depends on the dopant density of the polymer materials. The dopant density will determine the nature of the depletion region in the interface region, the transport properties of the layers, and the density of recombination centers that compete with luminescence.

The use of internally compensated conjugated ionomers is significant. Conventional doped n- and p-type polymers that are based on non-ionically functionalized conjugated polymers could not be used in such a device because dopant ion diffusion across the interface would to support a bulk redox reaction between the two materials, resulting in a chemically unstable device. Through the use of internally compensated ionomers, devices of the present invention do not experience dopant ion diffusion and are chemically stable.

### Example of p-i or n-i Structure Device

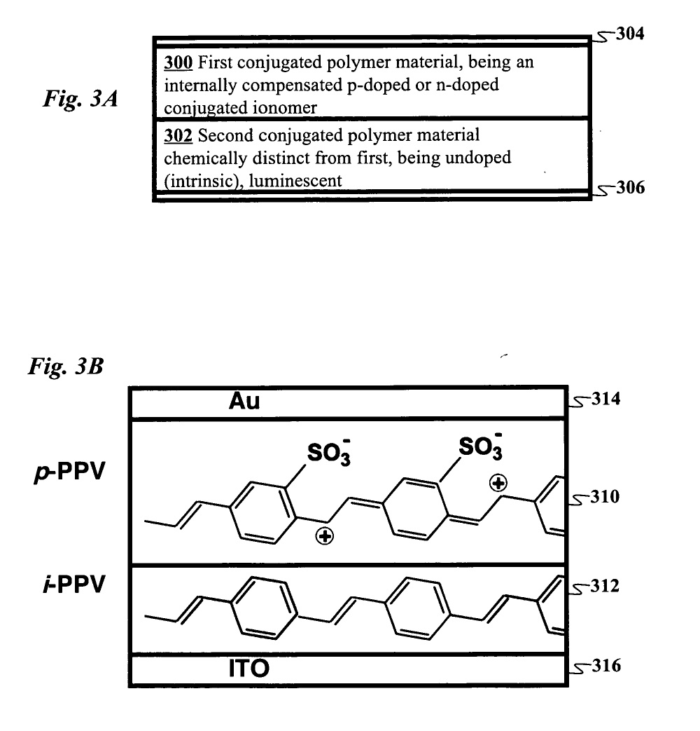

FIG. 3A illustrates an embodiment of the device which has a p-i or n-i structure. In this embodiment, the first conjugated polymer material layer 300 is p-doped or n-doped internally compensated conjugated ionomer, and the second conjugated polymer material layer 302 is an undoped (intrinsic) material that is luminescent. The first conjugated polymer material need not be luminescent, e.g., it may be a polyacetylene ionomer. The second conjugated polymer material is a luminescent material such as, for example, a poly(p-phenylene vinylene), a poly(fluorene), or a poly(terphenylene vinylene) polymer. The first and second layers may be based on the same type of luminescent polymer backbone but with distinct ionic functional groups. The two layers 300 and 302 are sandwiched between electrodes 304 and 306.

A particular example of this embodiment is illustrated in FIG. 3B. A first layer 310 is composed of a p-doped internally compensated conjugated poly(paraphenylene vinylene) polymer anionically functionalized with SO₃⁻. A second layer 312 is composed of an intrinsic luminescent conjugated poly(paraphenylene vinylene) polymer 310. The first layer 310 is contacted by a conventional electrode 314 composed of gold, calcium, aluminum, magnesium or indium tin oxide. More generally, any metal or transparent conducting oxide or other suitable conductive material may be used. A transparent electrode 316 such as ITO is in contact with intrinsic luminescent layer 312. Internal compensation prevents interfacial reactivity between layers 310 and 312 because there are no mobile counter-ions to support a bulk chemical reaction.

Example of p-i-n Structure Device

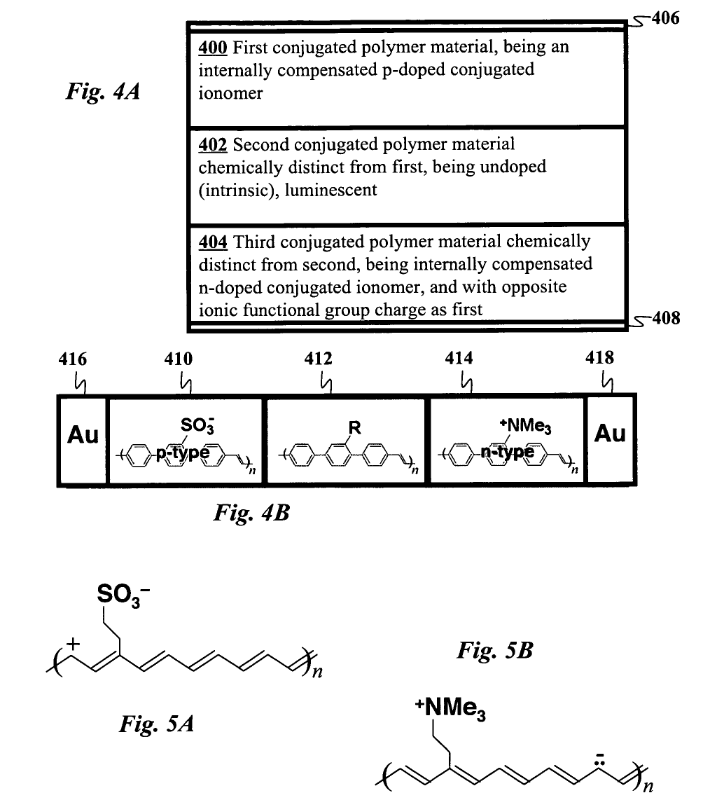

FIG. 4A illustrates an embodiment of the device which has a p-i-n structure. This embodiment is similar to the p-i or n-i embodiment discussed above in relation to FIGS. 3A and 3B, except that it has an additional layer of internally compensated doped conjugated polymer material. A first conjugated polymer material 400 is an internally compensated p-doped conjugated ionomer, and a third conjugated polymer material 404 is an internally compensated n-doped conjugated ionomer. The first and the third conjugated polymer materials 400 and 404 are ionically functionalized forms of conjugated polymers with oppositely charged ionic functional groups. They may be, for example, a non-luminescent ionomer such as those based on polyacetylene, or a luminescent ionomer such as those based on poly (p-phenylene vinylene), poly(fluorene), or poly(terphenylene vinylene) polymer. Sandwiched between these first and third material layers 400 and 404 is a second conjugated polymer 402 that is undoped (intrinsic) and luminescent. The second conjugated polymer material 402 may be, for example, a poly (p-phenylene vinylene), poly(fluorene), or poly(terphenylene vinylene) polymer. The first, second, and third layers are composed of chemically distinct polymer materials, i.e., with either different polymer backbones, different ionic functional groups, or both. The three layers 400, 402, 404 may be sandwiched between two electrodes 406 and 408.

A particular example of this embodiment is illustrated in FIG. 4B. A layer 412 composed of a luminescent, undoped (intrinsic) conjugated poly(terphenylene vinylene) polymer material is sandwiched between a layer 410 composed of an internally compensated p-doped conjugated poly(terphenylene vinylene) ionomer anionically functionalized with SO₃⁻ and a layer 414 composed of an internally compensated n-doped conjugated poly(terphenylene vinylene) ionomer cationically functionalized with NMe₃⁺, where Me is methyl. Any number of cationic functionalization would work in any of these situations, although ammonium species are the most common. Although the doped layers 410 and 414 in this example are luminescent polymers, they could alternatively be non-luminescent polymers such as polyacetylenes.

The doped layers 410 and 414 may be thought of as electron and hole injecting contacts into the intrinsic luminescent layer 412. With the application of voltage bias between electrodes 416 and 418, electrons from the n-doped layer 414 and holes from the p-doped layer 410 are injected into the intrinsic layer 412 where they recombine, producing emission of light. Preferably, the n- and p-doped layers 410 and 414 have their Fermi levels matched with the band edges of the luminescent intrinsic layer 412. In particular, it is desirable for efficient light emission that the Fermi level of the n-type material 414 is close to the conduction band edge of the intrinsic luminescent material 412 and that the Fermi level of the p-type material 410 is close to the valence band of the intrinsic luminescent material 412. To facilitate this matching, it is preferable that the same conjugated polymer backbone is used for all three layers 410, 412, 414. In addition, the selection of doping level in the doped layers 410 and 414 also affects their Fermi levels. Consequently, the light emission efficiency may be tuned by appropriate selection of the doping levels in these layers.

### Fabrication

Devices according to the present invention may be prepared by successive deposition and processing of its layers. For example, a device with a p-i structure (FIG. 3B) may be fabricated as follows. Beginning with an first electrode layer (e.g., ITO or other transparent conducting oxide or thin metal layer), the selected undoped poly(p-phenylene vinylene) (PPV) ionomer is deposited onto the electrode followed by electrochemical p-type doping to the internally compensated state to produce the internally compensated p-doped ionomer layer. The electrochemical doping may be performed using a liquid electrolyte based on a macromolecular salt.

Generally, the internally compensated state can be achieved by rinsing away any excess salt that might be incorporated, although a better-controlled route using electrochemical doping in the presence of macromolecular electrolytes may be used. A layer of undoped PPV is subsequently deposited from solution onto the p-doped layer to produce the intrinsic polymer layer. The entire structure is then mounted on a cooling stage in a thermal evaporator. The second metal electrode layer will then be evaporated with substrate cooling to minimize decomposition. The doping and polymer deposition may be conducted in a dry box and the structure transferred to the evaporator under a blanket of nitrogen. If needed, a more rigorous transfer to the evaporation chamber can be performed with a small transfer chamber with an electrically operated gate valve.

If the transparent electrode is composed of metal, its thickness is preferably less than 50 nm. The polymer layers are typically between 50 nm and 1000 nm. There is, in principle, no limit to the extent of these devices in the plane.

The diodes may be characterized by current-voltage measurements with simultaneously measurement of light intensity using a CCD interfaced to an integrating sphere. The Fermi level of the polymer may be varied by electrochemically controlling its doping level, as measured by its redox potential vs. a reference electrode. The more heavily doped samples will have a Fermi level closer to the valence band of the intrinsic layer and consequently should result in the lowest turn-on voltage. The use of doped, internally compensated polymers as charge injection contacts provides efficient and controllable charge injection. This will provides the light emitting devices with low turn-on voltage through good energy match and high efficiency through balanced electron and hole injection.

Conjugated ionomers suitable for use in devices of the present invention may be synthesized using various techniques known in the art, or suitable adaptations of such techniques. For example, polyacetylene ionomers with varying ionic functional group density and type may be synthesized using ring-opening metathesis polymerization (ROMP) and copolymerization of appropriately functionalized cyclooctatetraenes. For additional details, see the following articles: Langsdorf et al., Macromolecules 1999, 32, 2796; Langsdorf et al., Macromolecules 2001, 34, 2450-2458; Gorman et al., J. Am. Chem. Soc. 1993, 115, 1397-1409.

Through control of the monomer feedstock composition, polymers with ionic functional group densities ranging from 1 ionic functionality/4 double bonds to 1 ionic functionality/50 double bonds may be synthesized. Furthermore, these polymers all exhibit suitable solubility. For lower dopant densities, the solubility may be achieved through the addition of a trimethylsilyl (TMS) functionality.

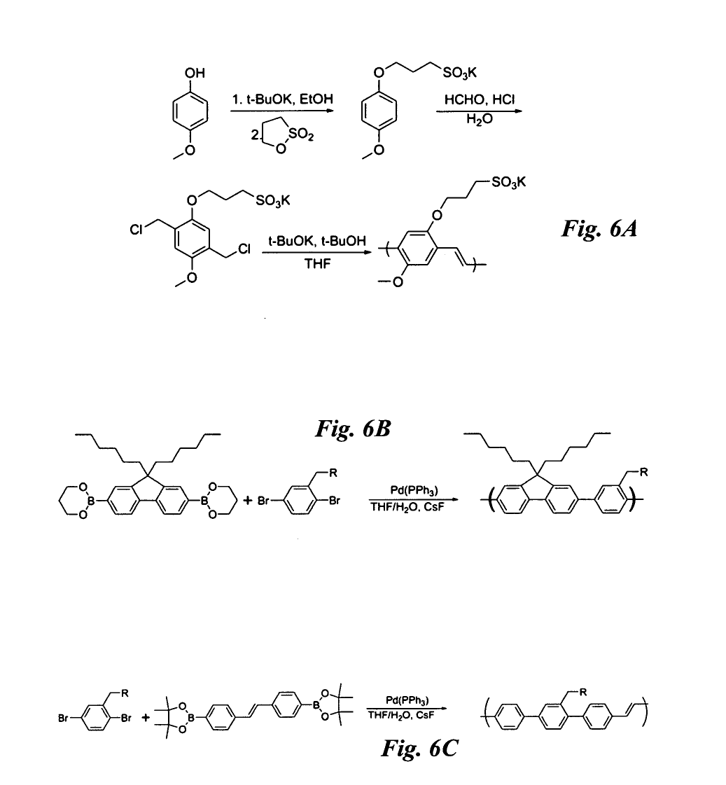

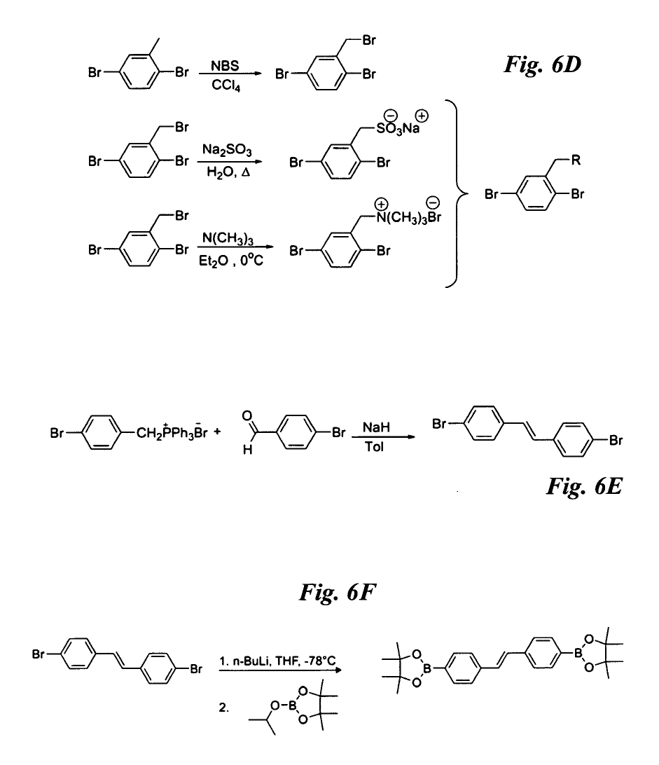

Luminescent polymers suitable for use in devices of the present invention may be synthesized using various techniques. For example, several types of conjugated ionomers based on poly(arylenes) or poly(arylene vinylene) backbones could be used. One such polymer is commercially available from sigma Aldrich (MPS-PPV), the synthesis of which is shown in FIG. 6A and described in Gu, Z.; Shen, Q-D.; Zhang, J.; Yang, C-Z.; Bao, Y-J, J App Poly Sci, 2006, 100, 2930-2936.

Other suitable polymers based on the poly(arylene) or poly(arylene-vinylene) backbone could be synthesized using standard coupling reactions. For instance, polyfluorene ionomers can be synthesized using an adaptation of a method developed for non-ionically functionalized polyfluorenes (Brookins, R. N.; Schanze, K. S.; Reynolds, J. R., Macromolecules, 2007, 40, 3524-3526) as shown in FIG. 6B.

Poly(terphenylenevinylene) ionomers can be similarly synthesized using an adaptation of the method developed for non-ionically functionalized poly(terphenylevinylene) ionomers (Kim, Y-H.; Ahn, J-H; Shin, D-C.; Kwon, S-K., Polymer, 2004, 45, 2525-2532) as shown in FIG. 6C.

In both the poly(fluorene) and poly(terpheyneylevinylene) structures above, the R represents the either anionic or cationic functionality. The necessary monomers can be synthesized according to the following schemes.

Dibromobenzes may be synthesized as shown in FIG. 6D. More specifically, 2,5-dibromotoluene (500 mg, 2.0 mmol) and NBS (534 mg, 3.0 mmol) are added to a round bottom flask to which CCl₄ (10 mL) is added. Slurry is brought to reflux and refluxed overnight. Reaction mixture is then washed with copious amounts of water. The organic layer is dried over MgSO₄ and filtered. Silica gel (30 g) is added to the organic layer and solvent removed in vacuo. Loaded silica is placed in filter and washed with hexanes until no more material comes through. Solvent is removed and obtained as a white solid.

Alpha,2,5-tribromotoluene (3.29 g, 10.0 mmol) is added to a solution of 1.26 g Na₂SO₃ in 40 mL of water. The tribromotoluene does not dissolve in the water but as the water is heated the tribromotoluene melts and forms a puddle on the bottom of the flask. This biphasic mixture is brought to reflux and refluxed for 60 hr. Reaction is not complete but the reaction is removed from heat, stirred and allowed to cool to room temperature. Product is crystallized from the water and separated by filtration while washing with ice cold water and ether.

Alpha,2,5-tribromotoluene (1.0 g, 3.04 mmol) is dissolved in 20 mL ether in round bottom flask with stir bar and septum. 5 mL trimethylamine is placed in separate flask with septum. The two flasks are connected with canula and stirred for three hours. N,N,N-trimethyl-(2,5-bibromobenzyl)ammonium bromide forms as a white precipitate in a few minutes and a large amount of white precipitate is formed at the end of the three hours. The precipitate is washed with ether and dried under vacuum.

Bibromostilbene may be synthesized as shown in FIG. 6E and as described in Kim, Y-H.; Ahn, J-H; Shin, D-C.; Kwon, S-K., Polymer, 2004, 45, 2525-2532.

Boronic ester may be synthesized as shown in FIG. 6F. Specifically, Bis-(4-bromophenyl)-1,2-trans-ethene (1.0 g, 2.95 mmol) is dissolved in dry THF (30 mL) and cooled to −78° C. Using a syringe, 2.5 M n-BuLi (2.48 mL, 6.21 mmol) is added to the suspension. This mixture is allowed to warm to 0° C. over 1 hour. The reaction mixture is again cooled to −78° C., at which point 2-isopropoxy-4,4,5,5-tetramethyl-132-dioxaborolane (2.11 mL, 10.35 mmol) is added by syringe. The reaction mixture is allowed to come to room temperature while stirring overnight. The reaction is then washed with water (2×100 mL) and brine (1×100 mL). The organic layer is dried over MgSO₄, filtered, and removed under vacuum. The solids are recrystallized from boiling hexanes to give the product as a white solid.

1. A light-emitting device comprising:
a first layer composed of a first conjugated polymer material; and
a second layer composed of a second conjugated polymer material;
wherein the first layer is in contact with the second layer;
wherein the first conjugated polymer material is chemically distinct from the second conjugated polymer material;
wherein the first conjugated polymer material is an internally compensated doped conjugated ionomer;
wherein the second conjugated polymer material is luminescent.

2. The device of claim 1 wherein the internally compensated doped conjugated ionomer has a doping density and an ion density, wherein the ion density is at least as large as the doping density.

3. The device of claim 2 wherein the doping density is at least 10¹³ per cm³ and the ion density is at most 10²³ per cm³.

4. The device of claim 1
wherein the first conjugated polymer material is luminescent;
wherein the first conjugated polymer material is an internally compensated p-doped conjugated ionomer and the second conjugated polymer material is an internally compensated n-doped conjugated ionomer;
wherein the first conjugated polymer material and the second conjugated polymer have oppositely charged ionic functional groups.

5. The device of claim 4 wherein the first conjugated polymer material and the second conjugated polymer material are ionically functionalized forms of a conjugated polymer selected from the group consisting of a poly(p-phenylene vinylene) polymer, a poly(fluorene) polymer, and a poly(terphenylene vinylene) polymer.

6. The device of claim 1 wherein the second conjugated polymer material is an undoped (intrinsic) material.

7. The device of claim 6 wherein the second conjugated polymer material is a conjugated polymer selected from the group consisting of a poly(p-phenylene vinylene) polymer, a poly(fluorene) polymer, and a poly(terphenylene vinylene) polymer.

8. The device of claim 6 wherein the first conjugated polymer material is an internally compensated doped conjugated polyacetylene ionomer.

9. The device of claim 6 wherein the first conjugated polymer material is an internally compensated p-doped conjugated ionomer.

10. The device of claim 9 wherein a Fermi level of the internally compensated p-doped conjugated ionomer is matched to a valence band edge of the undoped (intrinsic) material.

11. The device of claim 6 wherein the first conjugated polymer material is an internally compensated n-doped conjugated ionomer.

12. The device of claim 11 wherein a Fermi level of the internally compensated n-doped conjugated ionomer is matched to a conduction band edge of the undoped (intrinsic) material.

13. The device of claim 6 further comprising a third layer composed of a third conjugated polymer material;
wherein the third layer is in contact with the second layer, wherein the second layer is sandwiched between the first layer and the third layer;
wherein the third conjugated polymer material is chemically distinct from the second conjugated polymer material;
wherein the third conjugated polymer material is an internally compensated doped conjugated ionomer;
wherein the first conjugated polymer material is an internally compensated p-doped conjugated ionomer and the third conjugated polymer material is an internally compensated n-doped conjugated ionomer;
wherein the first conjugated polymer material and the third conjugated polymer have oppositely charged ionic functional groups.

14. The device of claim 13 wherein the second conjugated polymer material is a conjugated polymer selected from the group consisting of a poly(p-phenylene vinylene) polymer, a poly(fluorene) polymer, and a poly(terphenylene vinylene) polymer.

15. The device of claim 13 wherein the third conjugated polymer material is an internally compensated doped conjugated polyacetylene ionomer.

16. The device of claim 13 further comprising:
a first electrode in contact with the first layer;
a second electrode in contact with the third layer;
wherein the first layer and the second layer and the third layer are sandwiched between the first electrode and second electrode;
wherein at least one of the first electrode and the second electrode is transparent to visible light.

17. The device of claim 1 further comprising:
a first electrode in contact with the first layer;
a second electrode in contact with the second layer;
wherein the first layer and the second layer are sandwiched between the first electrode and second electrode;
wherein at least one of the first electrode and the second electrode is transparent to visible light.
